(19) United States
(12) Patent Application Publication
(10) Pub. No.: US 2005/0080820 A1
(43) Pub. Date: Apr. 14, 2005

(54) Method and system for generating, associating and employing user-defined fields in a relational database within an information technology system

(76) Inventors: Carl Arnold Koppel, Soquel, CA (US); Christian Allan Rofer, Felton, CA (US)

Correspondence Address: PATRICK REILLY, BOX 7218, SANTA CRUZ, CA, 95061-7218, US

(21) Appl. No.: 10/767,511

(22) Filed: Jan. 29, 2004

Related U.S. Application Data
(60) Provisional application No. 60/510,792, filed on Oct. 11, 2003.

(51) Int. Cl. G06F 17/00

(52) U.S. Cl. 707/104.1

(57) ABSTRACT

A system and method for creating and employing user-defined fields with an information technology system is provided. An exemplary computational system has a relational database and relational database management software program. The method of the present invention enables the creation of a user-defined field that may be associated with one or more records of one or more tables of a database of the computational system. Data may be appended to records without changing the schema of the table.

### RELATED PATENT APPLICATIONS

This patent application claims benefit of the priority date of U. S. Provisional Pat. Ser. No. 60/510,792 filed on Oct. 10, 2003, by inventors Koppel, C. and Rofer, A.

### FIELD OF THE INVENTION

The present invention relates to information technology systems that provide formatted information to, and/or retrieve information from, databases stored in communications systems, communications networks, and/or computational systems or networks. The present invention more particularly relates to methods, networks and systems used to maintain, manage and make accessible databases stored in digital media.

### BACKGROUND OF THE INVENTION

The access to databases of formatted information to selected and general audiences is a common and increasingly important benefit of database systems and Internet and electronic communications technologies and networks. The efficiency of providing one-to-many generation of formatted data is especially useful where one or more key elements or categories of the transmitted information are dynamic. The needs of many database users and managers to rapidly update databases and to promptly answer queries and generate reports, to either a selected user or a multiplicity of users, of the newly acquired and relevant information, by either push or pull information modalities, are key to providing the benefits of the information age to industry, government, the private sector, and the general public.

Relational databases are structured according to the paradigm of a two-dimensional table, wherein categories of information are specified as columns and defined along an x-axis, and records are defined as rows orthogonal to the categories of information. The records can be represented as containing information stored within data locations extending along the x-axis. These records may be further envisioned as layered upon each other along a z-axis. These prior art relational tables have limitations on the total quantity of categories of information that can be specified as residing along the x-axis. Second, the morphing of a database to encompass new categories of information may be difficult to effectively document and manage in an organization or network where a plurality or multiplicity of users may access, inter-relate and amalgamate data from a variety of databases. Third, developers of software products using databases have extreme difficulties in maintaining and upgrading their customer's installations, when each customer has altered the database structure to add new categories of information.

The continuous acquisition of new categories of data, and the provision of prodigious amounts of information to many database systems, and attempting to relate these new categories and high volumes of information to preexisting databases can strain the ability of a database manager to associate new data, or previously unassociated data, with a record of a database. Databases and database systems are typically designed in accordance with an understanding of limited and specific set of demands that the users will place upon the database. Yet the needs of the users and of organizations employing the database are likely to change over time. The prior art fails to completely address the needs of many database users to flexibly expand the categories of information associated with records stored within a database structure.

There is, therefore, a long-felt need for a method and a system that allows users to flexibly associate new data or previously unassociated data with a record stored within a database.

### OBJECTS OF THE INVENTION

It is an object of the present invention to provide a method that enables the association of data with a record of a database, without altering the database structure (“schema”).

It is a further object of certain preferred embodiments of the present invention to enable a user of a database to create a user-defined field (“UDF”) and to associate information stored within the UDF with a record of a database.

It is another object of certain alternate preferred embodiments of the present invention to enable a user of a database to create a user-defined field and to associate a list, and a data location within the list, with the user-defined field.

It is yet another object of certain still alternate preferred embodiments of the present invention to expand the categories of data associated with one or more records stored within a database.

### SUMMARY OF THE INVENTION

Towards these and other objects that will be apparent in light of the prior art and this disclosure, the present invention provides a method and system for creating and accessing user-defined fields in a software program metadata and optionally not in the schema of a table of data.

Application developers often need to provide the flexibility to users of their products so that they can create user-defined fields (“UDF's”) to extend the capabilities of the application. Traditionally, when these applications are based on relational databases, the formation of a UDF involves a request to create a new UDF as a new column within one or more tables in the underlying database schema. Supporting logic is then built within or by means of the database management software to support the new field.

A first preferred embodiment of the present invention provides a user-defined datafield, or “UDF”, structured according to a first UDF metadata design. The first UDF metadata design, or UDF metadata, allows for or stores (1) a UDF identifier of the UDF, (2) a classification of data type, e.g., integer, real number, ASCII, other suitable data type classification known in the art that the UDF may retain in a UDF datum datafield of the UDF, (3) an optional title of the UDF, and (4) an optional name of the UDF. The UDF, or ITEM-UDF, may include, and as allowed for by the UDF metadata, a UDF identifier datafield, a record identifier datafield, and a UDF datum datafield. The UDF identifier datafield may retain a software representation of an identifier of the UDF. The record identifier datafield may include a software representation of and identifier of a software record of a software database. The UDF datum datafield may retain a software representation of a UDF datum. The UDF datum will be classed according to the classification of data type UDF metadata, such as an integer, a real number, an alphanumeric character, or other suitable data type known in the art. The UDF may further optionally comprise a title as enabled by the UDF metadata, where the title may be made visible by an output device of an information technology system, and the title may be associated with the datum as stored in the UDF datum datafield. The output device of the information technology system may be a video display, a printer system, or other suitable information display or output system known in the art. The information technology system may be or comprise a computer workstation, a personal computer, a digital portable device, a computer network, the Internet, or other suitable computational device, in singularity or combination. The UDF may further optionally additionally or alternatively comprise a name as enabled by the UDF metadata, where the name may be associated with the UDF referenced within applications software, or in software documentation, or in or by other suitable software design or operation of the information technology system.

The method of the present invention may optionally comprise the provision of a computer-readable medium having stored thereon a data structure (the “UDF table”), including the user-defined field, or first UDF, the first UDF associated with a record stored in a table, the first UDF including (1) an identifier of the record, (2) an identifier of the first UDF, and (3) a first datafield for storing an information, whereby the first datafield is associated with the record and information may be stored in the first datafield and associated with the record and without modification of the table. The UDF table may further comprise a class plurality of UDF's, wherein the first datafield of the first UDF comprises a class identifier of the class plurality of UDF's, and each UDF of the class plurality includes (1) the class identifier (2) a unique identifier of the UDF of the class plurality of UDF's, and (3) a datafield, whereby (a) each of the datafields of the class plurality of UDF's may be associated with the first UDF and associated with the record, (b) information may be stored in the plurality of datafields of the class plurality of UDF's and associated with the first UDF, and (c) the information of the plurality of datafields of the class plurality of UDF's may be associated with the record and without modification of the table. The unique identifiers of the UDF and/or the record may each be or comprise a pointer.

Certain still alternate preferred embodiments of the method of the present invention may further provide a plurality of UDF's, each UDF having (1) an identifier of the first UDF, (2) a unique identifier of one of the plurality of UDF's, and (3) a datafield, where the plurality of datafields are associated with the first UDF and information may be stored in the plurality of datafields and associated with the first UDF, and therefrom the information of the plurality of datafields may be associated with the record and without modification of the table.

Certain yet alternate preferred embodiments of the method of the present invention may include a plurality of user-defined fields, or plurality of “UDF's”, each UDF associated with a record stored in a table, and each UDF.

Yet another alternate preferred embodiment of the method of the present invention provides computer-readable medium having stored thereon a data structure, the data structure having a record, a List and a list user-defined field, or “List UDF”, the List UDF relatable to the record. List UDF includes (1) an identifier of the List UDF, (2) an identifier of the List, and (3) a data address of the List, whereby an information stored at the data address of the List is associated with the List UDF and the information may be stored or modified at the data address of the List, and the information may be associated with the record and without modification of the table.

The first preferred embodiment of the present invention provides a method and a system that allows the creation of a plurality of UDF's within a software application, and without altering an underlying database schema. Optionally all the logic to support the use of the UDF may be made automatically available to the remainder of the software application.

The drawbacks of the prior art methods of adding UDF's are:
The UDF's are created by altering the underlying database schema, viz., adding new columns to tables. This makes applications difficult to maintain because application upgrades must often be completed in lockstep with database schema changes;
Software vendors working with multiple customers, each using different schemas, find it difficult or impossible to upgrade their software products at customer sites;
Logic must be built to support and maintain the data that resides within the UDF's. This building of underlying logic may be time-consuming and often complex;
Logic must be built to support the use of the field within the application; and.
The administrators of the system must have an intimate technical knowledge of the schema and the application source code to add UDF's.

The first preferred embodiment of the method of the present invention simplifies the process for a user of a data storage and management software application, optionally using one or more of the following techniques:
A simple visual screen is presented to a user and may be used to design a new UDF. The UDF is designed by specifying the following items of data within a data dictionary.
   NAME A name by which the UDF will be recognized and referenced within the application.
   UDF_ID A unique (among all UDF's in the database) number that is used to reference the UDF within the UDF management software. This number is automatically generated and is not used by the application.
   TITLE A title that will be displayed on screens and reports when referring to the UDF.

Note this title may be altered at any time, without changing the processing and functionality of the UDF itself. This provides a further advantage that the title to the UDF may be changed at will, and throughout the application using the UDF, without changing the data stored within the UDF.
DISPLAY TYPE A code that signifies how the UDF will be handled by the application. The display types include, but are not limited to: Date, Label, List, Number, User-ID, Text, Checkboxes, Radio Buttons, Images and Text.
These items are created as rows within the UDF table. This simple statement is the key to the power of the technique. The UDF is no longer created as a column within a table, but more simply as a row. A plurality of UDF's can be created in this way, each as a row (and within the data dictionary). Accreting and storing the UDF as a row enables the UDF and the original table to be associated without changing the underlying schema of either the table or the UDF.
If the display type is a List, then the first preferred embodiment of the method of the present invention has the optional capability to allow a list of valid values to be built for the UDF. The list may optionally be presented as a select list within the application. This refinement may not be required for other display types.
According to the display type, the first preferred embodiment of the method of the present invention may optionally have the in-built functionality to display the UDF. For example, if the user is viewing a data input screen and the display type is Date, then the application may automatically generate an input box, with a button to access a pop-up calendar. If the display type is a List, the application may generate a select box, correctly populated with the values that were defined for the list.
An additional and optional aspect of the first preferred embodiment of the method of the present invention is a fixed UDF database table (“ITEM_UDF table”) that is structured with the following columns:
   UDF_ID The internal key to the value being stored;
   RECORD_ID The record with which all the information for this specific UDF is associated;
   VALUE_TEXT The column where text values are stored;
   VALUE_NUMBER The column where numeric values are stored;
   VALUE_DATE The column where dates are stored; and
   VALUE_LIST The column where the selected value from a list is stored;

The ITEM_UDF database table may store some or all of the UDF values for a system, irrespective of the UDF itself. RECORD_ID uniquely specifies which record to which the UDF value belongs. The UDF_ID uniquely specifies the UDF associated with the specified record. There may be more than one row in the ITEM_UDF table with the same (RECORD_ID, UDF_ID) combination of values, allowing for multi-valued UDF's.

The summation of a primary optional advantage of the first preferred embodiment of the method of the present invention technology is that a UDF can be defined simply, with a small amount of information being held in a data dictionary. These UDF's can be associated with records within a software application, and the values of the UDF can thus be inserted, updated and deleted.

The optional advantages of the first preferred embodiment of the method of the present invention include:
Little or no software programming knowledge may be required to perform the complex operation of adding or maintaining a UDF;
Little or no specific database management expertise may be required to add or maintain a UDF;
The first preferred embodiment of the method of the present invention enables UDF's to be created without altering the structure of the database. This optional advantage leads to a much simpler environment for a software developer to support and upgrade;
No additional programming logic is required to support the handling of UDF's within an application; and

There are few or no limitations to the quantity of UDF's that can be defined for a software or software database application.

Other aspects of the present invention include an apparatus and a computer-readable medium configured to carry out the foregoing steps. The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which: These, and further features of the invention, may be better understood with reference to the accompanying specification and drawings depicting the preferred embodiment, in which:

FIG. 1 is a schematic diagram of an information technology network that includes at least one database.

FIG. 2 is a representation of a table of information comprised within the prior art database of FIG. 1.

FIG. 3A illustrates a user-defined field that associates information with a record of the table of FIG. 2.

FIG. 3B presents a metadata of the user-defined field of FIG. 3A.

FIG. 4 is a representation of a list stored within, associated with, or potentially of value in relating to the database of FIG. 1.

FIG. 5 illustrates a user-defined field that references the list and a data location within the list of FIG. 4 with a record of the table of FIG. 2.

FIG. 6 is a flow chart of the method of the present invention as actualized in FIGS. 1 thru 5.

FIG. 7 is a schematic diagram of the process on an alternate data structure of a second preferred embodiment of the method of the present invention.

FIG. 8 is a schematic diagram of a data structure designed according to a second preferred embodiment of the method of the present invention.

FIG. 9 is a schematic diagram of an alternate data structure.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

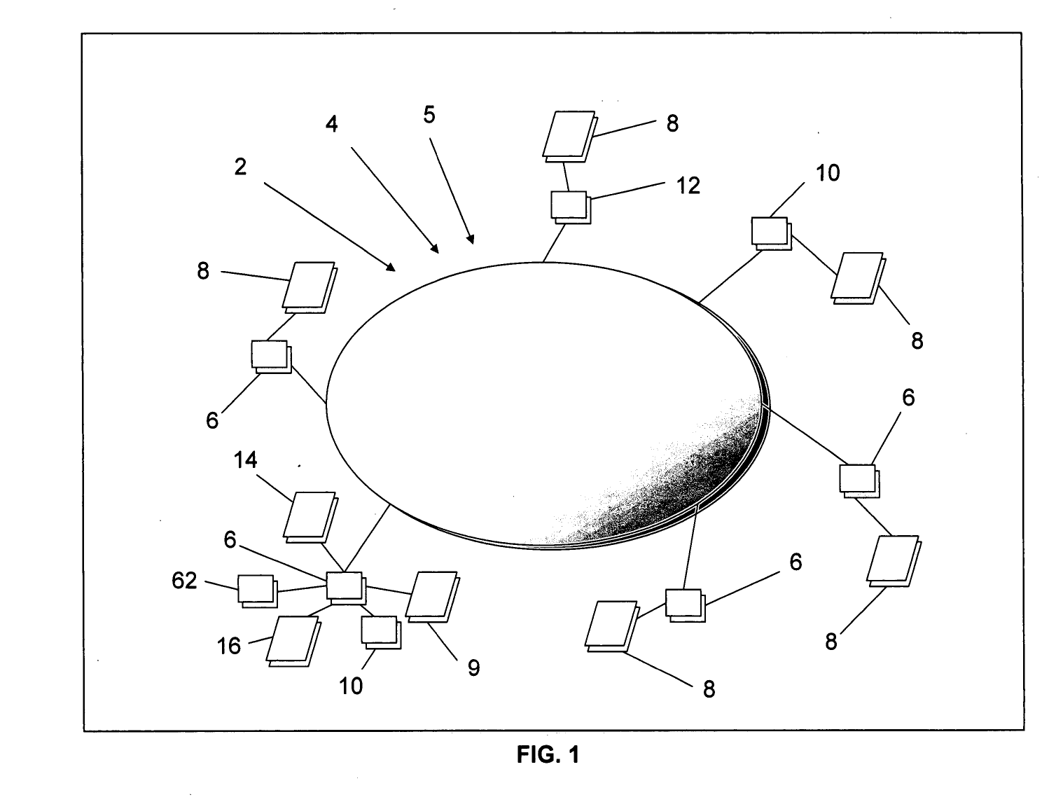

Referring now generally to the Figures and particularly FIG. 1, FIG. 1 illustrates computer network 2 optionally comprising the Internet 4 by which a first preferred embodiment of the method of the present invention 5 is implemented. The computer network 2, or network 2, links a plurality of participant computer systems 6, or systems 6, together for electronic messaging and data access. The network 2 communicates with prior art databases 8 and 9, computer-readable media storage devices 10 and web services computer systems 12. The database 8 may be stored entirely within a particular computer system 6 or may be distributed between two or more computers systems 6, or among three or more computer systems 6, and may optionally or alternatively be wholly or partially stored by means of one or more computer-readable media storage devices 10. The computer systems 6 are optionally capable of communications via the network 2. A computer system 12 is both capable of communications over the Internet and includes the prior art database 9, a database management software program 14, or database manager 14, and user-defined field storage software module 16, or UDF module 16.

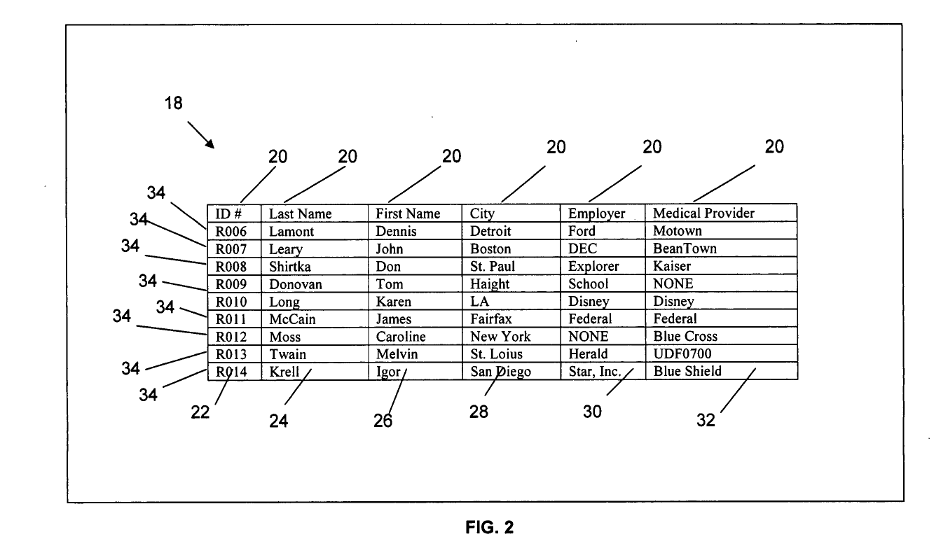

Referring now generally to the Figures and particularly FIG. 2, FIG. 2 is a representation of a table 18 of information comprised within the prior art database 9 of FIG. 1. The table 18 defines a series datafields 20 that store a unique record identifier 22, a customer last name 24, a customer first name 26, city of residence 28, employer 30, and a medical provider identification 32. The unique record identifier 22 may optionally be a pointer. A plurality of records 34 are then associated with table 18 wherein each record 34 is structured according to the series of datafields 20, each record having a unique record identifier 22. In the prior art method of record management, when a database manager would be tasked with associating new datafields with the preexisting table 18, the database manager might attempt to create a new column in the table 18 and thereby store and associate the new information. This prior art technique may present one or more of several problems. For example, the prior art database software might not permit a restructuring of the table 18. Or the table 18 might be accessed by other software programs that will fail to read the table 18 if the table 18 is restructured. Or a uniformity of table 18 with other similar tables accessed by a user may be necessary for an enterprise to maintain a level of coherence in managing a plurality or multiplicity of databases.

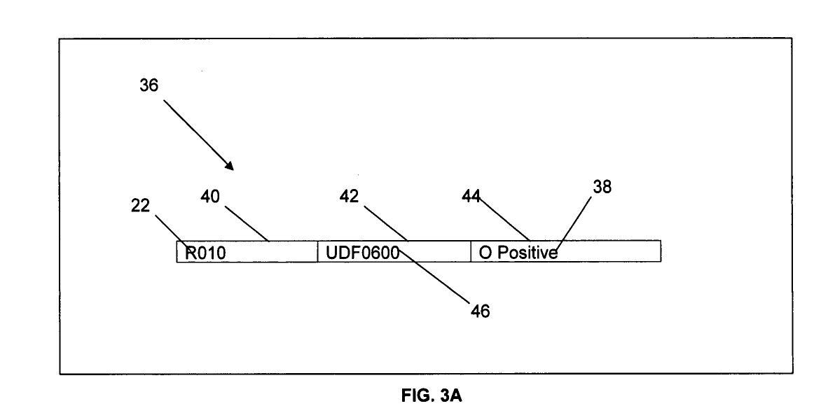

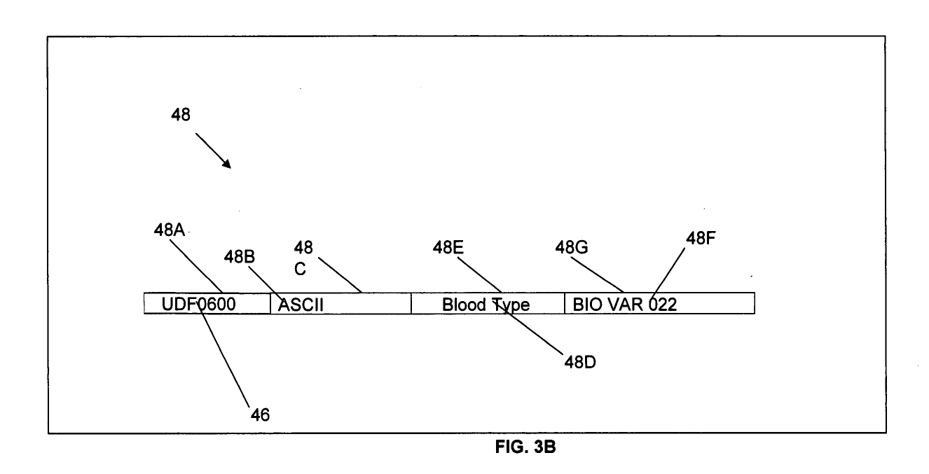

Referring now generally to the Figures and particularly FIG. 3A, FIG. 3A illustrates a single value of a user-defined field 36, or UDF 36, that associates information 38 with one record 34 of the table 18 of FIG. 2. The UDF 36 has a record identifier datafield 40, a UDF identifier datafield 42, and an information datafield 44. A record identifier 22 of a record 34 of the table 18 is stored in the record identifier datafield 40, UDF identifier 46 is stored in the UDF record identifier datafield 42, and the information 38 is stored in the UDF information datafield 44, or first datafield 44. The UDF identifier 46 and the record identifier 22 may optionally each or both be or comprise a pointer. The information 38 is thereby associated with the record 34 identified by the record identifier 22. In addition and optionally, the UDF 36 and the information 38 may be referred to within other aspects of the operation of the computer system 6 by means of selecting the UDF 36 on the basis of the UDF identifier 46. The UDF 36 is thereby created and associated with a record 34, and the UDF 36 is made available to the computer system 6 and optionally the network 2, without modifying the original and underlying schema of the table 18. The UDF 36 may optionally or alternatively be stored in a system software of the computer system 6, the UDF module 16, the database manager 14, and/or the prior art database 9.

Referring now generally to the Figures and particularly FIG. 3B, FIG. 3B presents a first UDF metadata design 48, or UDF metadata 48. The UDF metadata 48 is stored in the computer system 6, 12, or other suitable information technology system, and is associated with the UDF 36 by means of the UDF identifier 46. The UDF 36 is structured according to the design of the UDF metadata 48, whereby the UDF metadata provides or includes: (1) the UDF identifier 46 of the UDF 36 and as stored in the UDF metadata identifier field 48A, (2) a classification of data type 48B as stored in the data classifier field 48C, e.g., integer, real number, ASCII, other suitable data type classification known in the art that the UDF 36 may retain in a UDF datum datafield 44 of the UDF, (3) an optional UDF title 48D of the UDF 36 as stored in a UDF title datafield 48E, and (4) an optional UDF name 48F of the UDF 36 as stored in a UDF title datafield 48G. The UDF 36 may further optionally comprise the title 48D as enabled by the UDF metadata 48, where the title may be made visible by an output device of the information technology system, and the title may be associated with the datum as stored in the UDF datum datafield 44. The UDF 36 may further optionally additionally or alternatively comprise the UDF name 48 F as enabled by the UDF metadata 48, where the UDF name 48F may be associated with the UDF 36 referenced within applications software, or in software documentation, or in or by other suitable software design or operation of the computer network 2 or any suitable information technology system comprised within the computer network 2 or communicatively linked with the computer system 2.

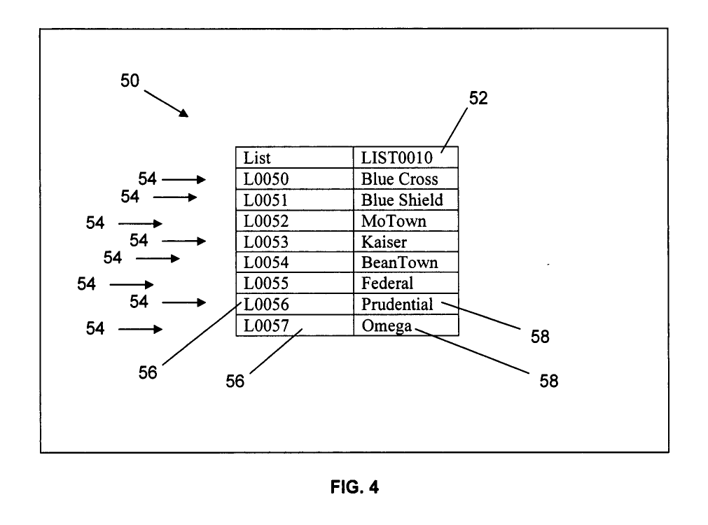

Referring now generally to the Figures and particularly FIG. 4, FIG. 4 is a representation of a list 50 stored within, associated with, or potentially of value in relating to the table 18 and the databases 8 and 9 of FIG. 1. The list 50 has a list identifier 52 and a series of ordered data pairs 54. Each ordered data pair 54 includes an item identifier 56 and a listed datum 58. The item identifier 56 relates to the location of the ordered data 54 within the list 50.

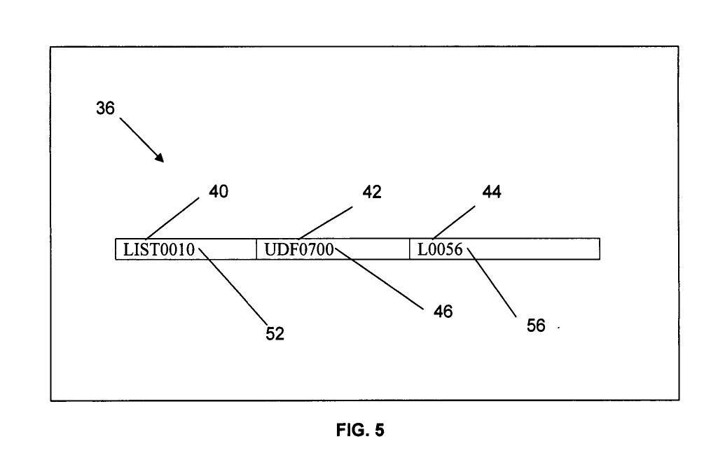

Referring now generally to the Figures and particularly to FIGS. 2, 3, 4, and 5, FIG. 5 illustrates a user-defined field 36, or UDF 36, that references the list 50 and an ordered data pair 54 of the list 50. The database manager may have designed one or more databases 8 or 9 so that the medical provider information 32 may be referred to in numerous tables 18 or records 34 stored within the database 8 or 9. The database manager, using a prior art method, may specify the medical provider in each of these stored references by explicitly storing the name of the relevant medical provider, such as a health maintenance organization, or HMO, in each instance where the identification of the medical provider is requested to be stored. Alternatively, the database manager may associate a UDF 36 with the instance where the identification of the medical provider is desired or required. The UDF 36 may include a name or another identifier of the medical provider in the information datafield 44. Storing the medical provider name or alternate identifying designation in the UDF 36 enables the data base manager to modify and update numerous individual records 34 that associate a medical provider with a particular individual or entity by simply updating the information datafield 44 of the referenced UDF 36. Alternatively, the database manager may use one or more lists 50 in combination with the UDF 36 to enable an efficient update of numerous records 34. For example, a person identified in the record 34 may switch health care providers on June 1 of a given year. One or more tables 18 of database 9 may identify the current health care provider of the person by storing a reference to the UDF 36. The UDF 36 may store the list identifier 52 in the record identifier datafield 40, and the item identifier 56 in the information datafield 44. The database manager may thus associate a plurality or multiplicity of references to a person's health care provider with a name or designation of a health care provider as stored in a plurality of references by (1) associating the UDF 36 with the health care provider reference in one or a multiplicity of records 34, and (2) storing the list identifier 52 and the item identifier 56, whereby the list datum 58 that includes the medical provider name or alternate designation may be associated with the records 34. The database manager may thereby update the records 34 by (1) changing the name or designation of the health care provider stored in the list 50 at the location of the list datum 58 specified by the item identifier 56, (2) updating the item identifier 56 stored within the UDF 36 with an alternate item identifier 56 that refers to a newly valid medical provider in the associated list datum 58, or (3) updating the UDF 36 with an alternate list identifier 52 and item identifier 56 of an alternate list 50, where the name or designation of the newly valid medical provider is stored in the associated listed datum 58. In a particular example, the table 18 of FIG. 2 shows that the medical provider of record R013 is designated by reference to UDF 36 UDF0700. The UDF 36 of FIG. 5 indicates that UDF0700 points to item number L0056 of the list number LIST0100. The designation of a medical provider associated with record R013 can be changed by (1) replacing the UDF identifier 46 in the medical provider datafield of R013 with an explicit designation of a medical provider (e.g., “Kaiser”), (2) changing the medical provider indicated at item number 58 L0056 of list number 52 LIST0100, or (3) changing the item number 56 stored in the information datafield 44 of the UDF0700, or (4) changing the list number 52 stored in the record identifier datafield 40 of the UDF 36 UDF0700.

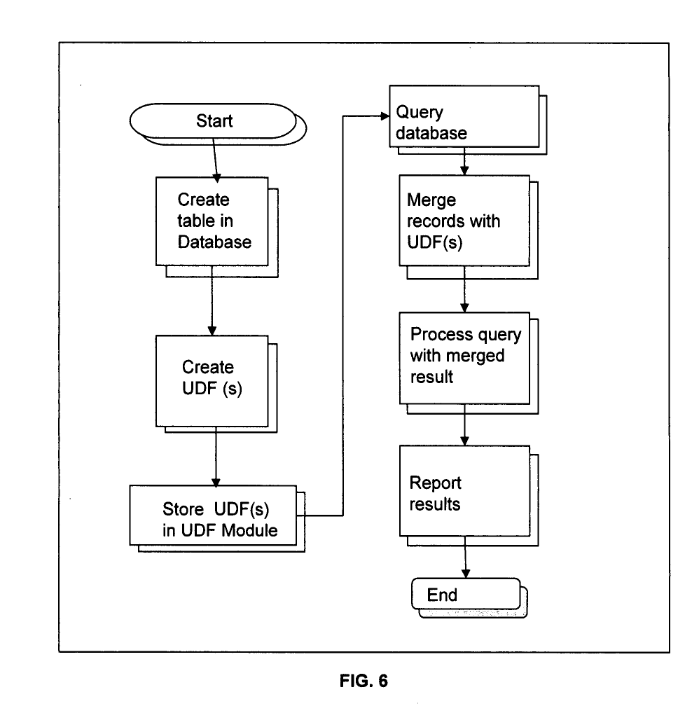

Referring now generally to the Figures and particularly FIG. 6, FIG. 6 is a flow chart of the method of the present invention as actualized in FIGS. 1 through 5. A user will create or receive the table 18 into the database 9. The user will then create one or more UDF's 36. When the database manager 14 queries the database 9 with a specific question, the database manager will merge the UDF's associated with the records 34 of the table 9 in the process of answering the query.

The first preferred embodiment of the present invention provides a method and a system that enables the creation of a plurality of UDF's 36 within a software application 60, and without altering an underlying database schema. The software application may be operable within one computer system 6 or by a plurality of computer systems 6 and via the network 2. Optionally all the logic to support the use of the UDF may be made automatically available to the remainder of the software application.

The drawbacks of the prior art method of adding UDF's 36 are:
The UDF's 36 are created by altering the underlying database schema, by adding new columns 62 to tables 18. This required addition of new tables 18 makes applications difficult for a software developer to maintain during an upgrade process and degrades a database manager's ability to enforce standardized schema policies partially or entirely throughout the network 2, and/or within one or more organizations, enterprises or ventures.
Logic must be built to support and maintain the data that resides within the UDF's 36. This work may be time-consuming and often technically and organizationally complex to establish and to execute.
Logic must be built to support the use of the UDF 36 within the application 60. The UDF 36 does not necessarily inherit all the characteristics of the application 60 itself.
The administrators or managers of the system must have an intimate technical knowledge of the schema and the source code of the application 60 to add UDF's 36.

The first preferred embodiment of the method of the present invention 5 simplifies the process for a user of a data storage and management software application, optionally using one or more of the following techniques:
A simple visual screen is presented to a user via a display screen 62 of a computer system 6 and may be used to design a new UDF 36. The UDF 36 is designed by specifying the following items of data within a data dictionary.
   NAME A name by which the UDF will be recognized and referenced within the application.
   UDF_ID A unique (among all UDF's in the database) number that is used to reference the UDF within the UDF management software. This number is automatically generated and is not used by the application.
   TITLE A title that will be displayed on screens and reports when referring to the UDF. Note this title may be altered at any time, without changing the processing and functionality of the UDF itself.
   DISPLAY TYPE A code that signifies how the UDF will be handled by the application. The display types include, but are not limited to: Date, Label, List, Number, User-ID and Text
These items may optionally be created as rows 62 associated with a table 9. This simple statement is the key to the power of the technique. The UDF 36 is no longer created as a column 64 within a table, but more simply as a row 62. A plurality of UDF's 36 can be created in this way, each as a row 62 (and optionally within a data dictionary of the database management software 14). A creating and storing the UDF 36 as a row structure enables the UDF 36 and the original table 18 to be associated without changing the underlying schema of either the table 18 or the UDF 36.
If the display type is a list 50, then the first preferred embodiment of the method of the present invention 5 has the optional capability to enable a list of valid values to be built for the UDF 36. The list 50 may optionally be presented as a select list within the application 60. This refinement may not be required for other display types.
According to the display type, the first preferred embodiment of the method of the present invention 5 may optionally have the in-built functionality to display the UDF 36. For example, if the user is using the display screen 62 of the computer system 6 as a data input screen and the display type is Date, then the application 60 may automatically generate an input box, with a button to access a pop-up calendar. If the display type is for a list 50, the application 60 may generate a select box, correctly populated with the values that were defined for the list 50.
An additional and optional aspect of the first preferred embodiment of the method of the present invention 5 is a fixed UDF database table (“ITEM_UDF table”) that is structured with the following columns:
   UDF_ID The internal key to the value being stored;
   RECORD_ID The record with which all the information for this specific UDF is associated;
   VALUE_TEXT The column where text values are stored;
   VALUE_NUMBER The column where numeric values are stored;
   VALUE_DATE The column where dates are stored; and
   VALUE_LIST The column where the selected value from a list is stored;

The ITEM_UDF database table may store some or all of the UDF values for a system, irrespective of the UDF itself. RECORD_ID uniquely specifies which record to which the UDF value belongs. The UDF_ID uniquely specifies the UDF associated with the specified record. There may be more than one row in the ITEM_UDF table with the same (RECORD_ID, UDF_ID) combination of values, allowing for multi-valued UDF's.

A primary optional advantage of the first preferred embodiment of the method of the present invention is that a UDF 36 can be defined simply, with a small amount of information being held in a data dictionary. These UDF's 36 can be associated with records 34 within a software application 6, and the values of the UDF 36 can thus be inserted, updated and deleted.

The optional advantages of the first preferred embodiment of the method of the present invention 5 include:
Little software programming knowledge may be required to perform the complex operation of adding a new UDF 36 to a system 6;
The first preferred embodiment of the method of the present invention 5 enables UDF's 56 to be created without altering the structure of the database 8 or 9. This optional advantage leads to a much simpler environment for a software developer to support and upgrade one or more tables 18 or a databases 8 and 9;
No programming logic is required to support the handling of UDF's 36 within an application 60; and
There are few or no limitations to the quantity of UDF's 36 that can be defined for an application 60.

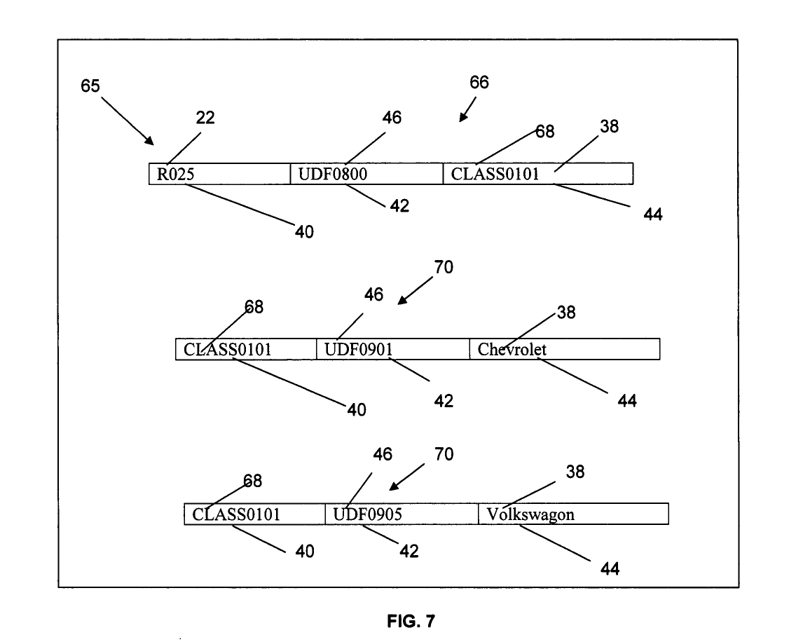

Referring now generally to the Figures and particularly FIG. 7, FIG. 7 is a schematic diagram of the data structure of a second preferred embodiment of the method of the present invention 65. The first UDF 66 has the UDF identifier 46 in the UDF identifier datafield 42, a record identifier 22 in the record identifier field 40, and a UDF class identifier 68 in the information datafield 44. The secondary UDF's 70 have the UDF identifier 46 in the UDF identifier field 42, the class identifier 68 of the first UDF 66 in the record identifier field 40, and an information 38 in the information datafield 44. It is understood that each UDF 36, 66, 70 possess a UDF identifier 46 that is sufficiently unique within the operation of the first and second preferred embodiment of method of the present invention 5 and 65 to enable the database management software 14 and the application software 60 to selectively distinguish and properly access each individual UDF 36, 66 and 70. The class identifier 68 as stored in the information field 44 of the first UDF 66 and in each of the record identifier fields 40 of the secondary UDF's 70 enable the database management software 14 and the software application 60 to associate the secondary UDF's 70 as each potentially possessing or designating information 38 of a certain shared aspect, quality or relevance.

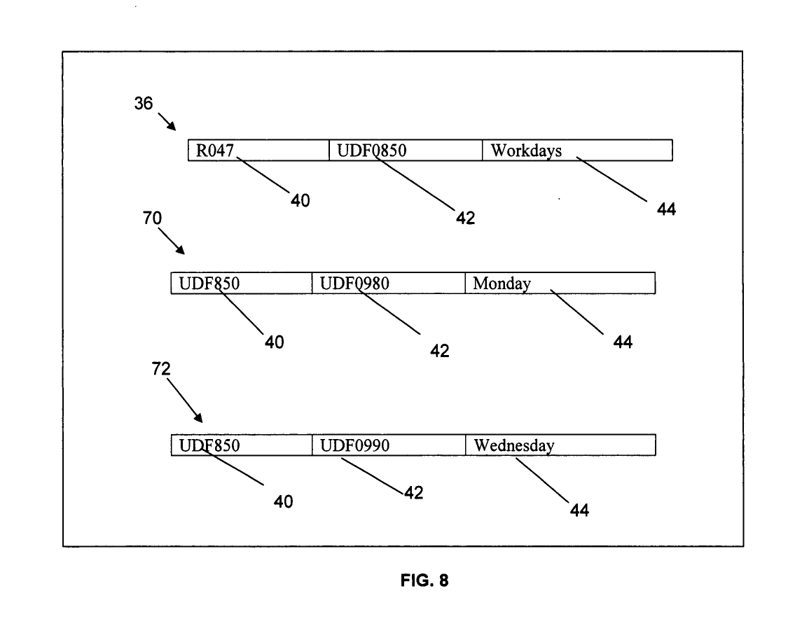

Referring now generally to the Figures and particularly FIG. 8, FIG. 8 is a schematic diagram of the data structure of a UDF 36 and a secondary UDF 70 that are designed in accordance with the second preferred embodiment of method of the present invention 65 and presenting an optionally applicable relationship wherein the record datafield 40 of the secondary UDF 70 stores the UDF identifier 46 of the UDF 36. The UDF 36 is thereby associated with the record 34 by means of the record identifier 22 stored in the record identifier datafield 40 of the UDF 36, and the information 38 stored in the information datafield 44 of the secondary UDF 70 is associated with the UDF 36 (and thereby with the record 34) by means of the storage of the UDF identifier 46 of the UDF 36 in the record datafield 40 of the secondary UDF 70. A third UDF 72 may additionally or alternatively comprise a storage of the UDF identifier 46 of the UDF 36 in the record identifier field 40 of the third UDF, a unique UDF identifier 46 of the third UDF 72 in the UDF identifier field 42 of the third UDF 72, and an information 38 of independent or dependent significance in the information datafield 44, whereby each of the informations 38 of the secondary datafield 70 and the third datafield may be associated with the UDF 36 and the record 34. Pluralities or multiplicities of the secondary UDF 70 and/or the third UDF 72 may be comprised within either the first or the second preferred embodiment of the present invention 5 and 65, whereby a plurality or a multiplicity of informations 38 as stored in a secondary UDF 70 or a third UDF 72 may be associated with a UDF 36. It is understood that the record identifier 22 and/or the UDF identifier 46 of the UDF 36 may optionally each or both be or comprise a pointer.

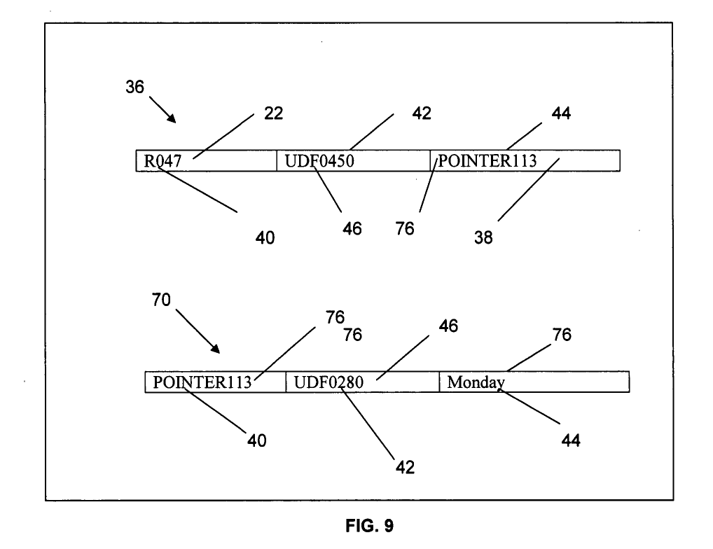

Referring now generally to the Figures and particularly FIG. 9, FIG. 9 is a schematic diagram of a data structure wherein the information datafield 44 of the UDF 36 comprises a pointer 72 to a secondary UDF 70, the secondary UDF 70 comprising (1) the UDF identifier 46 of the first UDF 36, (2) a UDF identifier 46 of the secondary UDF and (3) a second datafield 76, wherein the second datafield 76 is associated with the first UDF 36 and information 38 may be stored in the second datafield 74 and associated with the first UDF 36 and the information 38 of the second datafield 76 may be associated with the record 34 and without modification of the table 18.

The term “computer-readable medium” as used herein refers to any medium that participates in providing instructions to the network 2 for execution. Such a medium may take many forms, including but not limited to, non-volatile media, volatile media, and transmission media. Non-volatile media includes, for example, optical or magnetic disks, such as storage device 10. Volatile media includes dynamic memory. Transmission media includes coaxial cables, copper wire and fiber optics. Transmission media can also take the form of acoustic or light waves, such as those generated during radio-wave and infrared data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to the network 2 for execution. For example, the instructions may initially be carried on a magnetic disk of a remote computer. The remote computer can load the instructions into its dynamic memory and send the instructions over a telephone line using a modem. A modem local to or communicatively linked with the network 2 can receive the data on the telephone line and use an infrared transmitter to convert the data to an infrared signal. An infrared detector can receive the data carried in the infrared signal and appropriate circuitry can provide the data to the network 2.

Those skilled in the art will appreciate that various adaptations and modifications of the just-described preferred embodiments can be configured without departing from the scope and spirit of the invention. Other suitable techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

1. A computer-readable medium having stored thereon a data structure, the data structure having a first user-defined field, or first “UDF”, the first UDF associated with a record stored in a table, the first UDF comprising:
an identifier of the record;
an identifier of the first UDF; and
a first datafield, whereby the first datafield is associated with the record and additional information may be stored in the first datafield and associated with the record and without modification of the table.

2. The computer-readable medium of claim 1, wherein the computer-readable medium further comprises a metadata, the metadata associated with the first UDF, and the metadata comprising a classification of data type, the classification of data type distinguishing the data type of the additional information stored in the first datafield.

3. The computer-readable medium of claim 1, wherein the computer-readable medium further comprises a metadata, the metadata associated with the first UDF, and the metadata comprising a name, the name associated with the first UDF and the name for use in software operations accessing the first UDF.

4. The computer-readable medium of claim 1, wherein the computer-readable medium further comprises a metadata, the metadata associated with the first UDF, and the metadata comprising a title, the title associated with the first UDF and the name for use in a visual display of the additional information of the first UDF.

5. The data structure of claim 1, wherein the data structure further comprises a class plurality of UDF's and the first datafield comprises a class identifier of the class plurality of UDF's, and each UDF of the class plurality comprising:
the class identifier;
a unique identifier of the UDF of the class plurality of UDF's; and
a datafield, whereby each datafield of the class plurality of UDF's may be associated with the first UDF and therefrom associated with the record, and information may be stored in the plurality of datafields of the class plurality of UDF's and associated with the first UDF, and therefrom the information of the plurality of datafields of the class plurality of UDF's may be associated with the record and without modification of the table.

6. The data structure of claim 1, wherein the data structure further comprises a plurality of UDF's, each UDF comprising:
an identifier of the first UDF;
a unique identifier of one of the plurality of UDF's; and
a datafield, whereby the plurality of datafields are associated with the first UDF and information may be stored in the plurality of datafields and associated with the first UDF, and therefrom the information of the plurality of datafields may be associated with the record and without modification of the table.

7. The data structure of claim 1, wherein the identifier of the record is a pointer.

8. The data structure of claim 1, wherein the data structure comprises a plurality of user-defined fields, or plurality of “UDF's”, each UDF associated with a record stored in a table, and each UDF comprising:
an identifier of the record;
a unique identifier of one of the plurality of UDF's; and
a datafield, whereby the plurality of datafields are associated with the record and information may be stored in the plurality of datafields and the information of the plurality of datafields may be associated with the record and without modification of the table.

9. A computer-readable medium having stored thereon a data structure, the data structure having a record, a List and a list user-defined field, or “List UDF”, the List UDF relatable to the record, and the List UDF comprising:
an identifier of the List UDF;
an identifier of the List; and
a data address of the List, whereby an information stored at the data address of the List is associated with the List UDF and the information may be stored or modified at the data address of the List, and the information may be associated with the record and without modification of the table.

10. A computer system comprising:
a software database having data organized into a table of records;
a user-defined field for associating a datum with a record of the table, the user-defined field having a UDF identifier and a record identifier;
a metadata associated with the user-defined field and the metadata specifying the data type of the datum; and
a database manager software program for merging the user-defined field with the record to associate the datum of the user-defined field with the record of the table.
